(19) United States
(12) Patent Application Publication
(10) Pub. No.: US 2026/0327002 A1
(43) Pub. Date: Oct. 22, 2026

(54) FEMININE HYGIENE DISPOSAL BAG

(71) Applicant: Luma Mina, Fort Lauderdale, FL (US)

(72) Inventor: Luma Mina, Fort Lauderdale, FL (US)

(21) Appl. No.: 19/455,953

(22) Filed: Jan. 22, 2026

Related U.S. Application Data
(60) Provisional application No. 63/748,091, filed on Jan. 22, 2025.

(51) Int. Cl. B65F 1/00

(52) U.S. Cl. CPC B65F 1/002; B65F 2210/167; B65F 2230/00; B65F 2240/164

(57) ABSTRACT

A disposal bag is provided for discreet disposal of a feminine hygiene product. The disposal bag includes a bag body having a front wall, a rear wall, and a closeable opening that when open provides access to a receptacle compartment between the front wall and the rear wall. A bag opening mechanism allows a user to separate a top portion of the front wall from a top portion of the rear wall to form the opening to allow a feminine hygiene product to be placed within the receptacle compartment. A sealing mechanism adjoins the front wall to the rear wall to close the opening. The bag opening mechanism comprises a front wall finger slot on the front wall of the bag body and a rear wall finger slot on the rear wall of the bag body to open and close the disposal bag.

### PRIORITY

The present application claims the benefit of domestic priority based on U.S. Provisional Patent Application 63/748,091 filed on Jan. 22, 2025, the entirety of which is incorporated herein by reference.

### BACKGROUND

The disposal of feminine hygiene products has traditionally been a challenging task for women.

Women have a hard time effectively and discreetly disposing of their period products. Disposable period products, such as tampons, pads, liners, disposable panties, and the like can be difficult to discard of after use without leaking, odors, and/or visual recognition. This problem can be acerbated when a woman is in public or at the home of a companion or acquaintance and in need of disposing a used period product with the hopes of it being undetected.

Heretofore, a woman in need of discreet disposal of a period product has had few useful options. Often, a woman will simply throw a period product directly in the trash. However, this is not very hygienic, is easily detected by someone looking in the trash, and can leave a noticeable smell. To help alleviate these problems, a woman will sometimes wrap the used period product in toilet paper before throwing it in the trash, but in addition to this being wasteful and inconvenient, there remains the possibility of leaks and odor. Another option is to flush a used period product down the toilet. However, such flushing can cause plumbing problems and downstream contamination issues.

More recently, products have been designed for the purpose of disposing used period products, but with limited success. For example, the Fab Little Bag is available on the market and offers a bag designed to allow for the disposal of tampons and pads. However, the Fab Little Bag suffers from several drawbacks. For example, the Fab Little Bag is not discreet. It is sized, shaped, and marked for its purpose, and anyone seeing the bag with a product inside would know what the contents are. Also, the Fab Little Bag has a handle that is not efficient or comfortable to operate. The handles of the Fab Little Bag have slack and are positioned in the middle of a user's fingers making it uncomfortable to open and keep open. In addition, other bags that are made for the purpose of disposing period products are available, but these products also have disadvantages, such as lacking a handle, not being discreet, and/or not preventing leaks.

Therefore, there is a need for an improved feminine hygiene product. There is a further need for an improved period product disposal bag. There is a further need for a period product disposal bag that is discreet. There is a further need for a period product disposal bag that has improved handleability openability, and/or sealability.

### SUMMARY

The present invention satisfies one or more of these needs. In one aspect of the invention, an improved feminine hygiene product is provided.

In another aspect of the invention, an improved period product disposal bag is provided.

In another aspect of the invention, a discreet period product disposal bag is provided.

In another aspect of the invention, a discreet period product disposal bag is provided that has the appearance of a piece of toilet paper.

In another aspect of the invention, a period product disposal bag has improved handleability and/or openability.

In another aspect of the invention, a period product disposal bag has improved sealability and/or closeability.

In another aspect of the invention, a period product disposal bag has a finger slot on a front wall and a finger slot on a rear wall.

In another aspect of the invention, a period product disposal bag has a finger slot on a front wall and a finger slot on a rear wall, wherein the finger slots are elongate, extend across a majority of the width of the bag, and/or are closed on three sides to for a finger pocket.

In another aspect of the invention, a period product disposal bag has a finger slot on a front wall and a finger slot on a rear wall, wherein a seal mechanism is provided on the bag.

In another aspect of the invention, a period product disposal bag comprises an opening mechanism comprising a finger slot wherein the opening mechanism can include one or more of the following features: (i) a finger slot 170 that extends across a majority of the width of a front wall 110 of a disposal bag 100; (ii) a finger slot 170 that extends across at least 25 percent, or 35 percent, or 45 percent, or 55 percent, or 65 percent, or 75 percent, or 85 percent, or 95 percent, or 100 percent of the width of a front wall 110 of the disposal bag 100; (iii) a finger slot 170 that extends at least 1 inch, or at least 2 inches, or at least 3 inches, or at least 4 inches across the width of a front wall 110 of the disposal bag 100 (iv) a finger slot opening 180 at or near a side, such as the left side 120, of the disposal bag 100; (v) a finger slot opening 180 within 1 inch, or 0.5 inches, or 0.25 inches of a side, such as the left side 120, of the disposal bag; (vi) a finger slot 170 having an opening 180 connected at its top and at its bottom to the front wall 110 of the disposal bag 100 wherein the top connection and/or the bottom connection is at or near, such as by being within 1 inch, or 0.5 inches, or 0.25 inches, a side, such as a left side 120, of the disposal bag 100; (vii) a finger slot opening 180 that has a curvature when viewed from the front of the disposal bag; (viii) a finger slot opening 180 that has angled edges when viewed from the front of the disposal bag 100; (ix) a finger slot opening 180 that is indented or has an indented portion to facilitate finger insertional and/or visualization; and (x) a finger slot opening 180 that has a tab or flange to facilitate finger insertional and/or visualization.

In another aspect of the invention, a method of disposing of a used period product comprises providing a period product disposal bag as described herein and using the period product disposal bag as described herein.

In another aspect of the invention, a period product disposal bag dispenser is provided.

In another aspect of the invention, a disposal bag for disposal of a feminine hygiene product comprises a bag body comprising a front wall and a rear wall, the bag body having a left side, a right side, a bottom, and a top, wherein the top includes a closeable opening that when open provides access to a receptacle compartment between the front wall and the rear wall; a bag opening mechanism adapted to allow a user to separate a top portion of the front wall from a top portion of the rear wall to form the opening to allow a feminine hygiene product to be placed within the receptacle compartment; and a sealing mechanism adapted to adjoin the top portion of the front wall to the top portion of the rear wall to close the opening and secure the feminine hygiene product within the disposal bag, wherein the bag opening mechanism comprises a front wall finger slot on the front wall of the bag body and a rear wall finger slot on the rear wall of the bag body, wherein the front wall finger slot has a front wall finger slot opening on or near the left or right side, wherein the rear wall finger slot has a rear wall finger slot opening on or near the same left or right side, and wherein the front wall finger slot extends across at least 55 percent of the width of the front wall of the bag body.

In another aspect of the invention, a disposal bag for disposal of a feminine hygiene product comprises a bag body comprising a front wall and a rear wall, the bag body having a left side, a right side, a bottom, and a top, wherein the top includes a closeable opening that when open provides access to a receptacle compartment between the front wall and the rear wall; a bag opening mechanism adapted to allow a user to separate a top portion of the front wall from a top portion of the rear wall to form the opening to allow a feminine hygiene product to be placed within the receptacle compartment; and a sealing mechanism adapted to adjoin the top portion of the front wall to the top portion of the rear wall to close the opening and secure the feminine hygiene product within the disposal bag, wherein the bag opening mechanism comprises a front wall finger slot on the front wall of the bag body and a rear wall finger slot on the rear wall of the bag body, wherein the front wall finger slot has a front wall finger slot opening on or near the left or right side, wherein the rear wall finger slot has a rear wall finger slot opening on or near the same left or right side, and wherein the front wall finger slot is connected to the front wall on three sides.

In another aspect of the invention, a method of disposing of a feminine hygiene product comprises providing a disposal bag comprising a bag body comprising a front wall and a rear wall, the bag body having a left side, a right side, a bottom, and a top, wherein the top includes a closeable opening that when open provides access to a receptacle compartment between the front wall and the rear wall a bag opening mechanism adapted to allow a user to separate a top portion of the front wall from a top portion of the rear wall to form the opening to allow a feminine hygiene product to be placed within the receptacle compartment; and a sealing mechanism adapted to adjoin the top portion of the front wall to the top portion of the rear wall to close the opening and secure the feminine hygiene product within the disposal bag, wherein the bag opening mechanism comprises a front wall finger slot on the front wall of the bag body and a rear wall finger slot on the rear wall of the bag body, wherein the front wall finger slot has a front wall finger slot opening on or near the left or right side, and wherein the rear wall finger slot has a rear wall finger slot opening on or near the same left or right side; inserting a first finger of a first hand into the front wall finger slot; inserting a second finger of the first hand into the rear wall finger slot; separating the first finger from the second finger to open the opening; placing a used period product through the opening and into the receptacle compartment using a second hand; moving the first finger towards the second finger to close the opening and to adjoin the top portion of the front wall to the top portion of the rear wall across a majority of the width of the bag body; and disposing of the disposal bag.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic perspective view from the front and left side of a version of a disposal bag of the invention;

FIG. 1B is a schematic perspective view from the front and right side of the disposal bag of FIG. 1A;

FIG. 2A is a schematic perspective view from the front and above of the disposal bag of FIG. 1A;

FIG. 2B is a schematic side view of the disposal bag of FIG. 1A;

FIG. 3A is a schematic top view of the disposal bag of FIG. 1A in use;

FIG. 3B is a schematic side view of the disposal bag of FIG. 1A in an open position;

FIG. 4 is a schematic perspective view from the front and above of another version of a disposal bag of the invention;

FIG. 5A is a schematic perspective view from the front and left side of another version of a disposal bag of the invention;

FIG. 5B is a schematic perspective view from the front and right side of the disposal bag of FIG. 5A;

FIG. 6 is a schematic front view of another version of a disposal bag of the invention;

FIG. 7 is a schematic front view of another version of a disposal bag of the invention;

FIG. 8 is a schematic front view of another version of a disposal bag of the invention;

FIG. 9 is a schematic front view of another version of a disposal bag of the invention;

FIG. 10 is a schematic front view of another version of a disposal bag of the invention;

FIG. 11 is a schematic front view of a portion of a version of a disposal bag of the invention;

FIG. 12 is a schematic front view of another version of a disposal bag of the invention;

FIG. 13A is a schematic front view of a dispensing system for disposal bags of the invention in a storage condition;

FIG. 13B is a schematic front view of the dispensing system of FIG. 13A in a dispensing condition;

FIG. 14A is a first step in a process of using a dispenser bag of the invention;

FIG. 14B is a second step in a process of using a dispenser bag of the invention;

FIG. 14C is a third step in a process of using a dispenser bag of the invention; and

FIG. 14D is a fourth step in a process of using a dispenser bag of the invention.

### DESCRIPTION

The present invention relates to a feminine hygiene product. In particular, the invention relates to a woman's period product disposal bag. Although the invention is illustrated and described in the context of being useful for discreetly containing a period product, the present invention can be used in other ways, as would be readily apparent to those of ordinary skill in the art. Accordingly, the present invention should not be limited just to the examples and embodiments described herein.

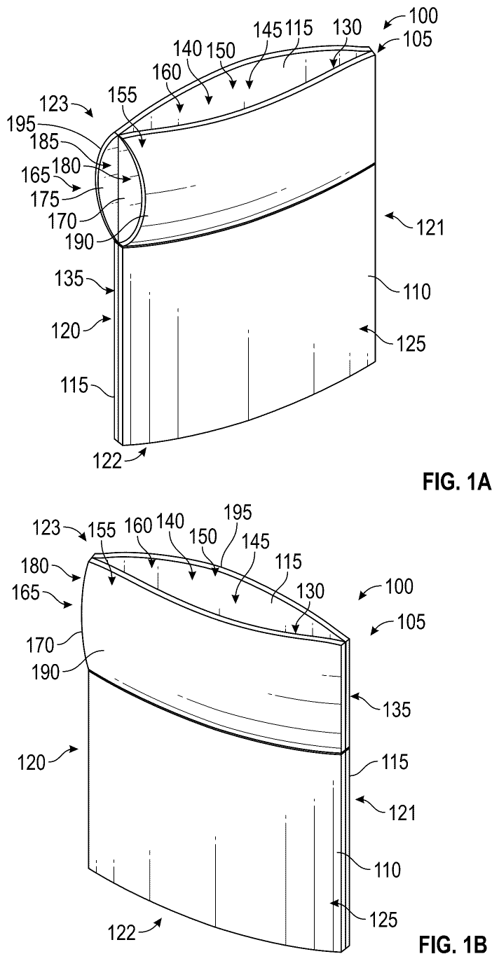

FIGS. 1A and 1B show a version of a disposal bag 100 of the present invention. The disposal bag 100 is particularly designed for the discreet disposal of one or more feminine hygiene products, such as a woman's period product. By woman's period product it is meant any product used during the course of a woman's menstruation to collect, block, and/or hide a woman's menstrual fluid and/or other menstruation discharge. Examples of period products include tampons, pads, liners, toilet paper, menstrual cups, menstrual discs, disposable underwear, and the like, and portions thereof, whether or not the period products actually contain or capture any signs of menstruation. The disposal bag 100 can also be used to carry and/or dispose of any other items, such as a used condom, that a woman might wish to dispose of discreetly. The disposal bag 100 of FIGS. 1A and 1B has a bag body 105 made up of a front wall 110 and a rear wall 115. In the version shown, the disposal bag 100 includes a left side 120, a right side 121, a bottom 122, and a top 123. The left side 120, right side 121, and bottom 122 can be at least partially joined together and/or connected at seams or edges of the front wall 110 and the rear wall 115 or can be separate surfaces. The front wall 110 has a front wall outer surface 125 and a front wall interior surface 130, and the rear wall 115 has a rear wall outer surface 135 and a rear wall interior surface 140. The front wall 110 and the rear wall 115 are joined together on at least the left side 120, right side 121, and bottom 122 so as to define a receptacle compartment 145 between the front wall interior surface 130 and the rear wall interior surface 140. The top 123 of the disposal bag 100 includes an opening 150 or mouth that provides access to the receptacle compartment 145. A front wall top portion 155 and a rear wall top portion 160 can be separated from one another to create the opening 150. Accordingly, at least a portion of the front wall top portion 155 and the rear wall top portion 160 are unjoined or unjoinable.

The disposal bag 100 also includes a bag opening mechanism 165 adapted to help create and/or expand the opening 150 in the top 123 of the disposal bag 100 for easier access to the receptacle compartment 145. In the version of FIGS. 1A and 1B, the bag opening mechanism 165 comprises a front wall finger slot 170 and a rear wall finger slot 175. The front wall finger slot 170 is a cavity that extends into or is connected to the front wall 110 from a front wall finger slot opening 180. Similarly, the rear wall finger slot 175 is a cavity that extends into or is connected to the rear wall 115 from a rear wall finger slot opening 185. In the version of FIGS. 1A and 1B, the front wall finger slot opening 180 and the rear wall finger slot opening 185 are at or near the left side 120 of the disposal bag 100. Alternatively, the slot openings can be on the right side 121. The front wall finger slot 170 is connected to the front wall top portion 155 in proximity to the top opening 150 and the rear wall finger slot 175 is connected to the rear wall top portion 160 in a manner where a movement of the front wall finger slot 170 away from the rear wall 115 and/or movement of the rear wall finger slot 175 away from the front wall 110 cause the front wall top portion 155 and the rear wall top portion 160 to be separated from each other in a manner that creates and/or expands the top opening 150. In the particular version of FIGS. 1A and 1B, the front wall finger slot 170 is formed by a front outer piece of material 190 being connected to the front wall 110 at or near the front wall top portion 155, such as by being attached to the front wall 110 at the front outer piece of material top and bottom and optionally right side. By not being connected at the front outer piece of material left side, the front wall finger slot opening 180 is created. Similarly, in the version of FIGS. 1A and 1B, the rear wall finger slot 175 is formed by a rear outer piece of material 195 being connected to the rear wall 115 at or near the rear wall top portion 160, such as by being attached to the rear wall 115 at the rear outer piece of material top and bottom and optionally right side, when viewing from the front of the disposal bag 100. By not being connected at the rear outer piece of material left side, the rear wall finger slot opening 185 is created. Accordingly, in this version, the front wall finger slot 170 is formed by a double layer portion of the front wall 110, and the rear wall finger slot 185 is formed by a double layer portion of the rear wall 115.

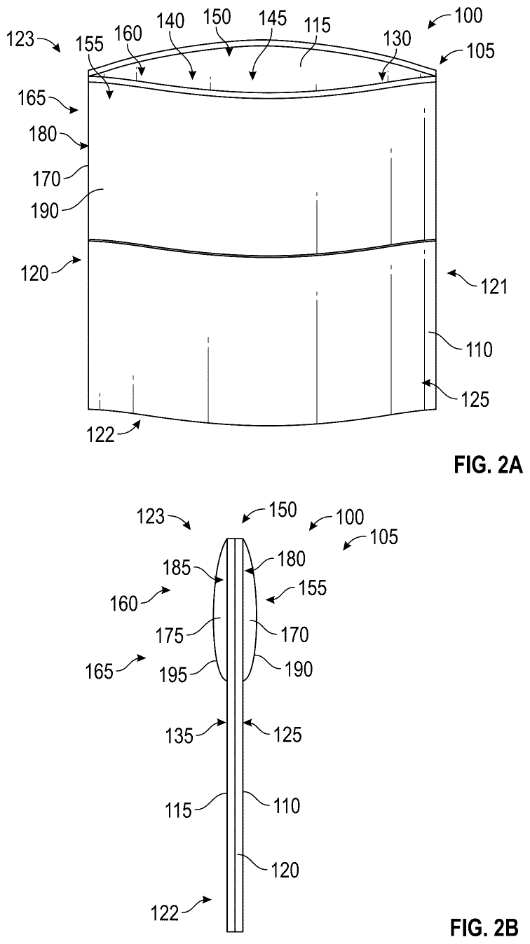

Additional views of the disposal bag 100 of FIGS. 1A and 1B are shown in FIGS. 2A and 2B. FIG. 2A shows a perspective view from the front and above with the opening 150 partially open, and FIG. 2B shows a view from the left side with the front wall finger slot 170 and the rear wall finger slot 175 slightly separated. The walls are sufficiently flexible that when lying flat or being stored, the opening 150 and the front wall finger slot 170 and rear wall finger slot 175 are more closed than shown.

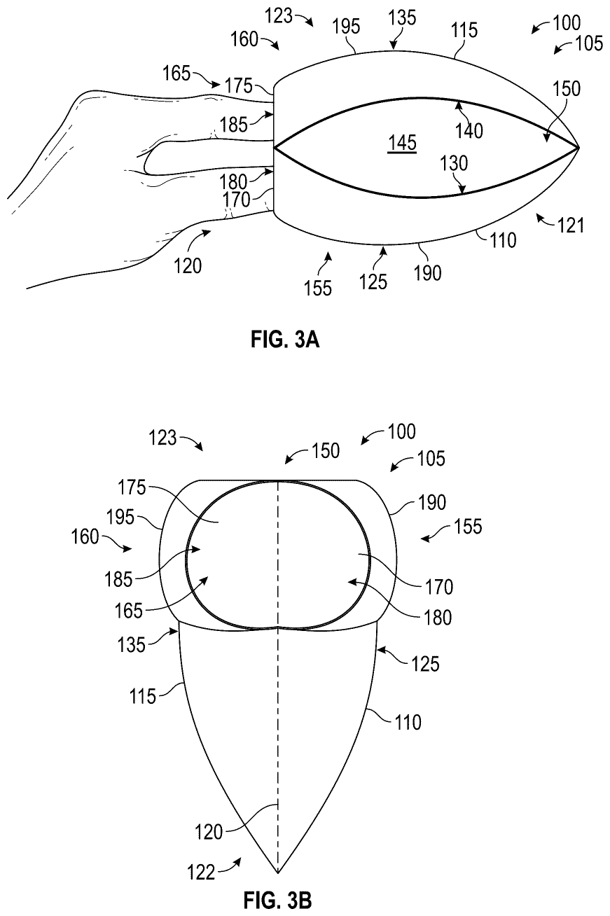

Operation of the disposal bag 100 of the version of FIGS. 1A and 1B is shown in FIGS. 3A and 3B. FIG. 3A illustrates a top view of the disposal bag 100 with a user's fingers being inserted into the front wall finger slot 170 and the rear wall finger slot 175 and being spread apart to cause an expansion of the top opening 150. FIG. 3B shows a side view of the process with the user's fingers removed for clarity. In use, a user can use two fingers, such as a thumb and index finger, to open the disposal bag 100 and create the opening 150 into the receptable compartment 145. The user can then use their other hand to place a used period product or other object into the receptacle compartment 145. The top opening 150 can then be closed, such as by bringing the fingers back together while the fingers are in the front finger slot 170 and rear finger slot 175 or removing the user's fingers from the front finger slot 170 and/or the rear finger slot 175 and manually pushing the front wall top portion 155 towards the rear wall top portion 160, or in a manner to be described hereinbelow. The used period product can then be safely and discreetly contained within the receptacle compartment 145.

In one version, the disposal bag 100 may be designed so that it resembles in appearance an object that would not give away the identity of the content being stored in the receptable compartment 145. For example, in the particular version shown, the bag body 105 of the disposal bag 100 is designed to resemble a piece of toilet paper. In this version, the disposal bag 100 is sized, shaped, and optionally colored to look like a piece of toilet paper. With this version, when the disposal bag 100 is placed in a trash can or the like, a casual observer would hardly notice the presence of the disposal bag 100 thinking it merely to be a loose piece of toilet paper. Accordingly, this version of the disposal bag 100 comprises a material that is white or off-white and that this rectangular in shape with dimensions ranging from about 3 inches to about 10 inches in width and from about 3 inches to about 10 inches in height. In one version, the width and height can be within about 20 percent of each other to simulate a toilet paper square. Accordingly, in one particular version, the width can be from about 4 inches to 5 inches, and the height can be from about 4 inches to 5 inches. The material of the disposal bag 100 can be selected to be durable, flexible, sufficiently opaque to not be easily seen through, to resist sticking together, and to be eco-conscious. Examples of materials that can be used include one or more of plastics, polyethylene (PE), low-density polyethylene (LDPE), high-density polyethylene (HDPE), medium-density polyethylene (MDPE), polypropylene (PP), polyvinyl chloride (PVC), polyethylene terephthalate (PET), biodegradable plastics, polylactic acid (PLA), polyhydroxyalkanoates (PHA), coated or modified plastics, coated plastics, blended plastics, thermoplastic elastomers (TPE), paper-based materials, wax-coated paper, poly-coated paper, laminated paper, natural materials, cellulose-based films, natural rubber, starch-based polymers, additives or treatments for enhanced properties, anti-static additives, antimicrobial additives, pigments and dyes, embossed or textured materials, laminated films, bioplastic blends, silicone coatings.

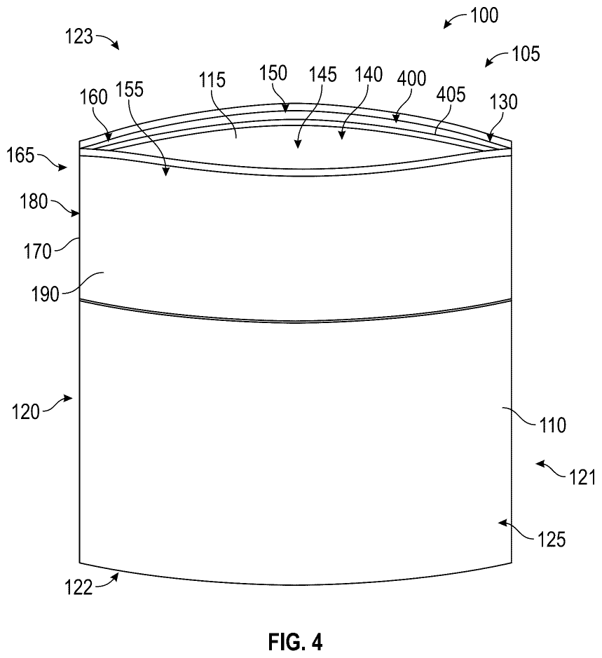

Another version of a disposal bag 100 of the invention is shown in FIG. 4. In this version, a sealing mechanism 400 is provided that is capable of at least partially closing the opening 150 be connecting the front wall top portion 155 and the rear wall top portion 160, such as by joining the front wall interior surface 130 and the rear wall interior surface 140, as shown in the version of FIG. 4. The sealing mechanism can be, for example, an adhesive strip 405 mounted on one of the front wall 110 or the rear wall 115 and adherable to the other of the front wall 110 and the rear wall 115. For example, the adhesive strip can be initially provided with a protective cover member that can be removed to activate the adhesive and allow the adhesive to adhere to the other wall when the opening 150 is closed. At the end of the adhesive strip 405 there can be a small section that holds the peel-off in place in order for it to not detach from the bag body 105. Under the adhesive there is a line of sealant or glue, so when the above strip is peeled off, a person can then close their fingers together and stick the glue side with the other side that is plastic. The sealing mechanism 400 helps to secure the period product within the receptacle compartment 145 and can help to prevent odors and leaks.

The adhesive strip 405 can take on any suitable size, shape, and/or placement, as will be discussed. For example, the adhesive can comprise one or more of synthetic adhesives, hot-melt adhesives (HMAs), pressure-sensitive adhesives (PSAs), epoxy adhesives, polyurethane (PU) adhesives, cyanoacrylate adhesives, acrylic adhesives, natural adhesives, plant-based adhesives, animal-based adhesives, natural rubber adhesives, water-based adhesives, polyvinyl acetate (PVA) adhesives, latex adhesives, acrylic emulsion adhesives, solvent-based adhesives, chloroprene rubber adhesives, polyurethane solvent-based adhesives, contact adhesives, specialty adhesives, silicone-based adhesives, UV-cured adhesives, thermosetting adhesives, anaerobic adhesives, conductive adhesives, biodegradable and sustainable adhesives, soy-based adhesives, lignin-based adhesives, gelatin-based adhesives, additives and modifications for adhesives, anti-tack additives, fillers, plasticizers, colorants and dyes. Alternatively, the adhesive strip can be replaced by any other form of closure, such as a hook and loop fastener, a zipper, snaps, and the like.

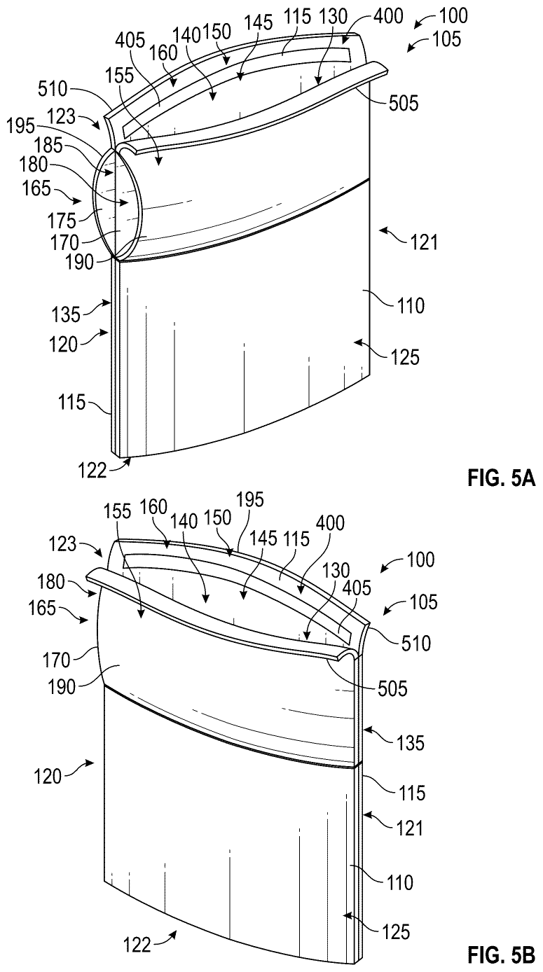

FIGS. 5A and 5B show another version of a disposal bag of the invention. In the version of FIGS. 5A and 5B, the front wall 110 includes a front flap 505 at the top of the front wall top portion 155, and the rear wall 115 includes a rear flap 510 at the top of the rear wall top portion 160. The front flap 505 and the rear flap 510 extend above the front wall finger slot 170 and the rear wall finger slot 175, respectively. The front flap 505 and the rear flap 510 are not connected on their respective ends. The separation of the front flap 505 and the rear flap 510 allow for the adhesive and adhesive cover to fully go across the opening of the bag. In addition, the opening 150 is wider which makes it easier to insert a period product into the receptacle compartment 145. Also, the separation helps make the accessing the peel of the adhesive easier. This also allows for a near complete seal which can help reduce or prevent leaks and/or odors.

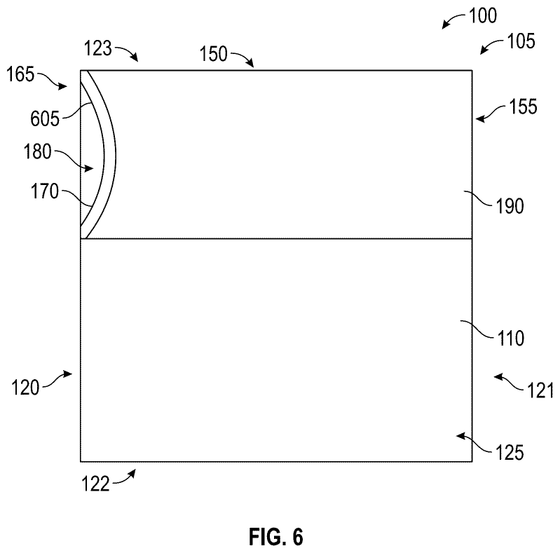

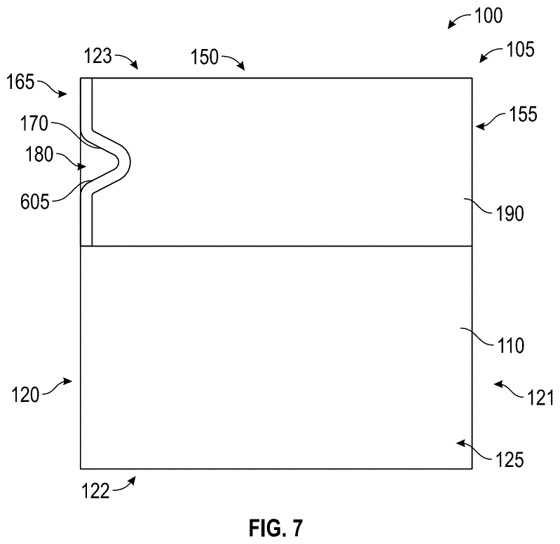

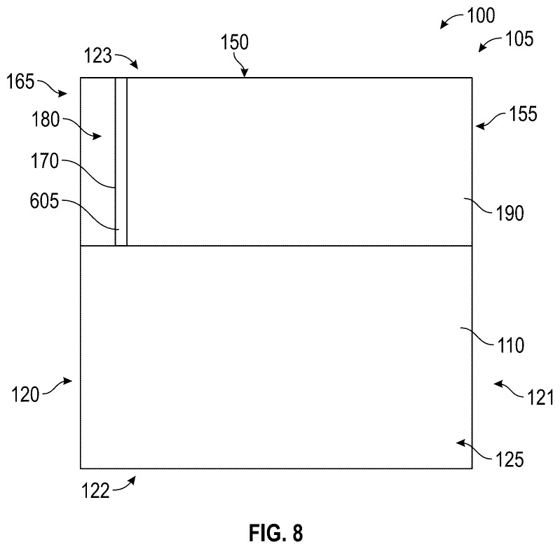

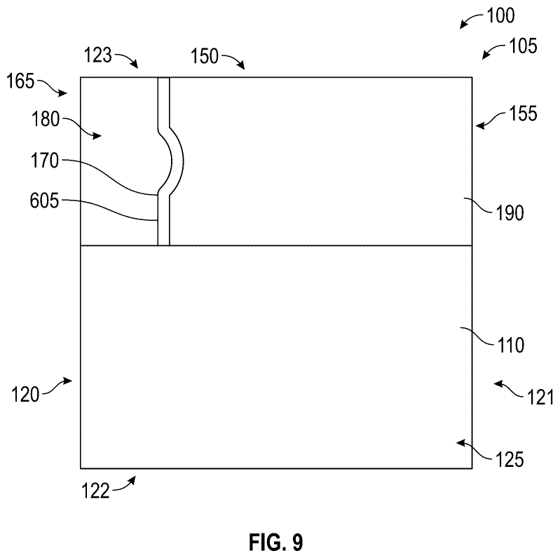

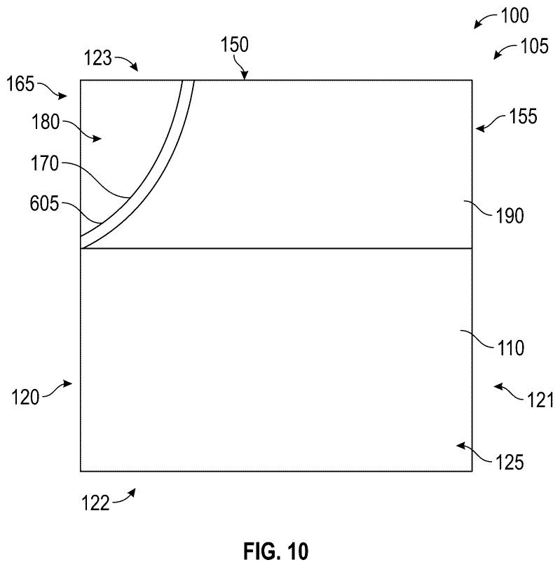

FIGS. 6-10 different designs of bag opening mechanisms 165. For example, as shown in FIG. 6, the bag opening mechanism 165 can include an indent portion 605 on the front outer piece of material 190 and/or on the rear outer piece of material 195. The indent portion 605 makes it easier for a user to find the front wall finger slot opening 180. In the version of FIG. 6, the indent portion 605 is curved. In the version of FIG. 7, the curved portion is only in the center of the front wall finger slot opening 180. In the version of FIGS. 8 and 9, the entirety of the front wall finger slot opening 180 is indented. In the version of FIG. 10, the indent portion 605 is arcuate with one end not indented. In the versions of each of FIGS. 6-10, the rear wall finger slots 175 can be the same, similar, or a mirror image as the front wall finger slots 170 of the version or can be different, such as by being similar to a different version.

As can be seen in one or more of the versions of FIGS. 6-10, the disposal bag 100 is characterized by an improved bag opening mechanism 165. The bag opening mechanism 165 is designed to make the opening and/or closing of the disposal bag 100 easier, more convenient, less conspicuous, more easily manufacturable, and/or more securely closeable. Accordingly, to one or more of these ends, the disposal bag 100 opening mechanism can include one or more of the following features: (i) a finger slot 170 that extends across a majority of the width of a front wall 110 of a disposal bag 100; (ii) a finger slot 170 that extends across at least 55 percent, 75 percent, or 95 percent, or 100 percent of the width of a front wall 110 of the disposal bag 100; (iii) a finger slot 170 that extends at least 2 inches, at least 3 inches, at least 4 inches across the width of a front wall 110 of the disposal bag 100 (iv) a finger slot opening 180 at or near a side, such as the left side 120, of the disposal bag 100; (v) a finger slot opening 180 within 1 inch, or 0.5 inches, or 0.25 inches of a side, such as the left side 120, of the disposal bag; (vi) a finger slot 170 having an opening 180 connected at its top and at its bottom to the front wall 110 of the disposal bag 100 wherein the top connection and/or the bottom connection is at or near, such as by being within 1 inch, or 0.5 inches, or 0.25 inches, a side, such as a left side 120, of the disposal bag 100; (vii) a finger slot opening 180 that has a curvature when viewed from the front of the disposal bag; (viii) a finger slot opening 180 that has angled edges when viewed from the front of the disposal bag 100; (ix) a finger slot opening 180 that is indented or has an indented portion to facilitate finger insertional and/or visualization; and (x) a finger slot opening 180 that has a tab or flange to facilitate finger insertional and/or visualization.

In one particular version, the bag opening mechanism 165 is particularly designed to improve the separation of the front wall top portion 155 and the rear wall top portion 160 to create the opening 150 through which a used period product can be placed. To that end, a finger slot 170, 175 that extends across at least 55 percent, 75 percent, or 95 percent, or 100 percent of the width of a front wall 110 of the disposal bag 100 is particularly useful in creating an desirably sized and shaped opening 150 by separation of a user's finger and thumb that are inserted into the front finger wall finger slot 170 and the rear wall finger slot 175, respectively. By spreading out one or both of the finger slots 170, 175 at least 55 percent, 75 percent, or 95 percent, or 100 percent, more uniform pressure can be applied across the opening thereby increasing the ease with which the opening can be created and increasing the width of the opening. In contrast, a slot that extends across less of the width of the disposal bag 100 will be harder to open and will not open as widely nearer the left side 120 and right side 121, and this can make it difficult to easily place a used period product in the receptacle compartment 145. The creation of the opening 150 can also be improved and/or facilitated by having the end of the front wall finger slot 170 and/or rear wall finger slot 175 at least partially closed or sealed on its end opposite to the front wall finger wall opening 180 and/or rear wall finger slot opening 185. For example, when the front wall finger slot opening 180 is on the left side 120, as in the versions shown, the right side 121 of the front wall finger slot 170 can be at least partially closed or sealed or connected to the front wall 110. This connection helps to pulls the parts apart and causes additional separation of the front wall top portion 155 and the rear wall top portion 160, especially on the side opposite the front wall finger slot opening 180. Accordingly, in one version the front wall finger slot 170 is connected to the front wall 110 on three sides and the only side not connected in the side of the front wall finger slot opening 180. Similarly, the rear wall finger slot 175 can be connected to the rear wall 115 on three sides and the only side not connected in the side of the rear wall finger slot opening 185. This arrangement forms a finger pocket on the front wall 110 and a finger pocket on the rear wall 115.

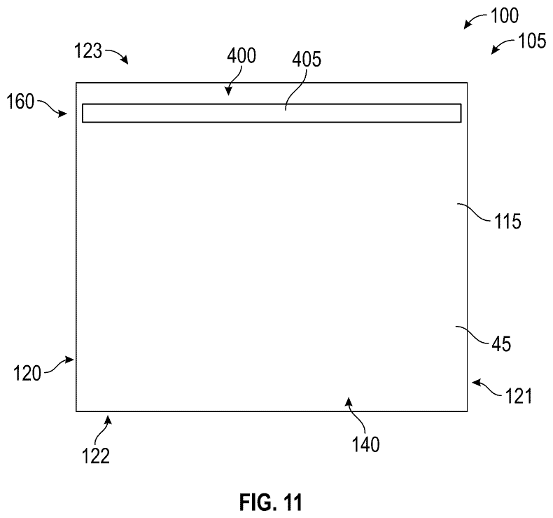

FIG. 11 shows the rear wall 115 of the disposal bag 100 of FIG. 4 with the front wall 110 removed for clarity to show an example of the positioning of the sealing mechanism 400 and adhesive strip 405. The adhesive strip 405 includes an adhesive layer and a cover layer. The cover can be removed by a user to expose the adhesive layer. When a user has a bag in one hand, they will usually use their other hand to dispose of their used period product. Once the used period product is placed within the receptacle compartment 145, the user then peels the adhesive cover off the adhesive layer from left to right, or from the middle up, or right to left, etc. Then once the cover is off, the user can either discard of the cover in the receptacle compartment 145, throw it away elsewhere, or it can be designed to remain attached. The user then brings their fingers together to seal the disposal bag 100.

In addition, by having the finger slots 170, 175 extend across at least 55 percent, 75 percent, or 95 percent, or 100 percent of the width of a front wall 110 of the disposal bag 100, the sealing of the disposal bag 100 is easier and improved. By merely squeezing the fingers back together after a period product has been placed in the receptacle compartment 145 and after the cover to the adhesive is removed, the rear wall 115 will be adhered to the front wall across a majority of the width of the disposal bag 100. The user can then optionally use their other fingers to complete the seal.

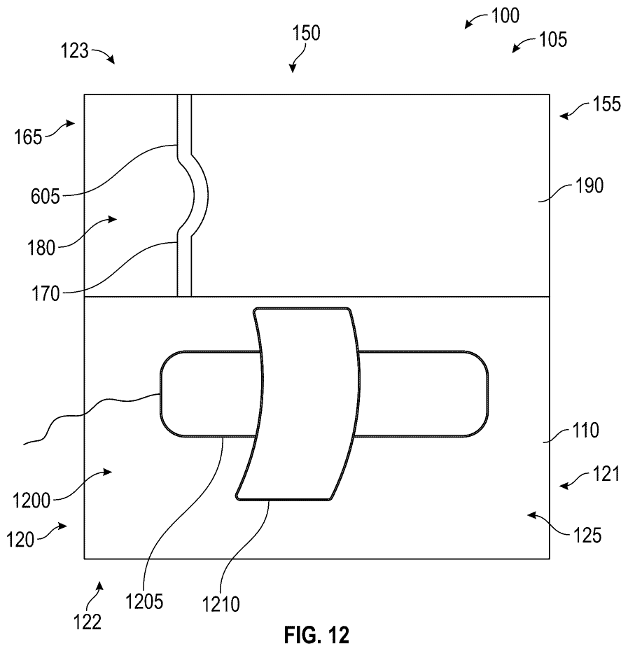

FIG. 12 shows a version of a disposal bag 100 of the invention in which a period product 1200 is provided on, in, or attached to the bag body 105. For example, in FIG. 12 a tampon 1205 is provided. Alternatively, a pad or other period product can be provided. A strap 1210 can also be provided to help secure the period product 1200 to the bag body 105.

In one version, each disposal bag 100 can be connected by a tear line at the bottom or top of the bag body 105 that has small divots in it so that it can easily rip off of one another. Each bag is connected from alternating sides in order to ensure that every time a bag is taken out, the other will come out with the finger pockets or slots in the correct orientation. Alternatively, the bags 100 can be folded into one another in a way so that when one gets pulled out, the other comes directly behind it. For example, when you look at it straight on, the first bag on the stack has the finger pockets on the left side and at the top of the bag, then the next bag still has the finger pockets on the left side except it is now oriented downwards. Each bag takes turns orienting upwards and downwards in order for it to be dispensed correctly each time.

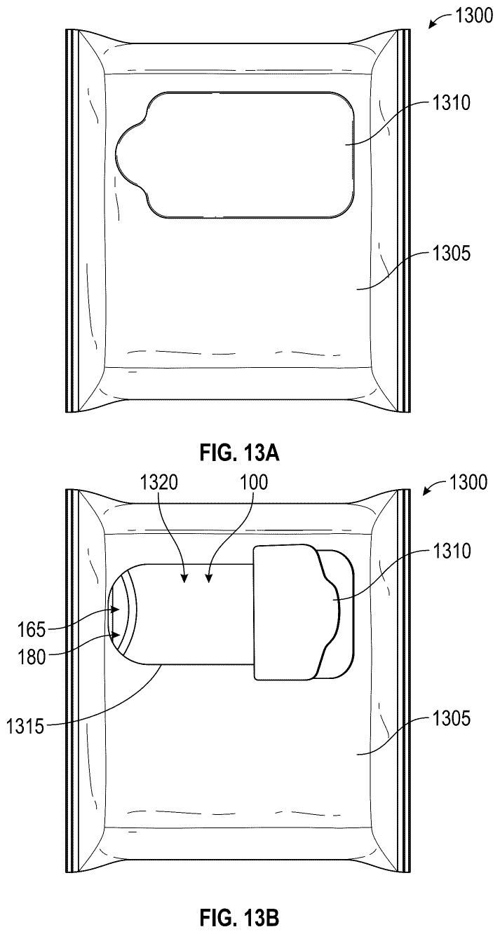

FIGS. 13A and 13B show a storage and dispensing system 1300 that can be used to store and/or dispense a plurality of disposal bags 100 of the invention. The storage and dispensing system 1300 includes a dispenser body 1305 that has a general shape that corresponds to the shape of a disposal bag 100. A resealable cover member 1310 selectively covers a dispenser opening 1315 that provides access to an interior 1320 of the dispenser body 1305 in which a plurality of disposal bags 100 can be stored. As can be seen in the version shown, the dispenser opening 1315 is aligned with the bag opening mechanism 165, such as by being aligned with the front wall finger slot opening 180 of the disposal bags 100 contained within the dispenser body 1305. This allows the bag opening mechanism 165, such as the front wall finger slot opening 180, to be used to pull a disposal bag 100 from the dispenser body 1305 and out the dispenser opening 1310.

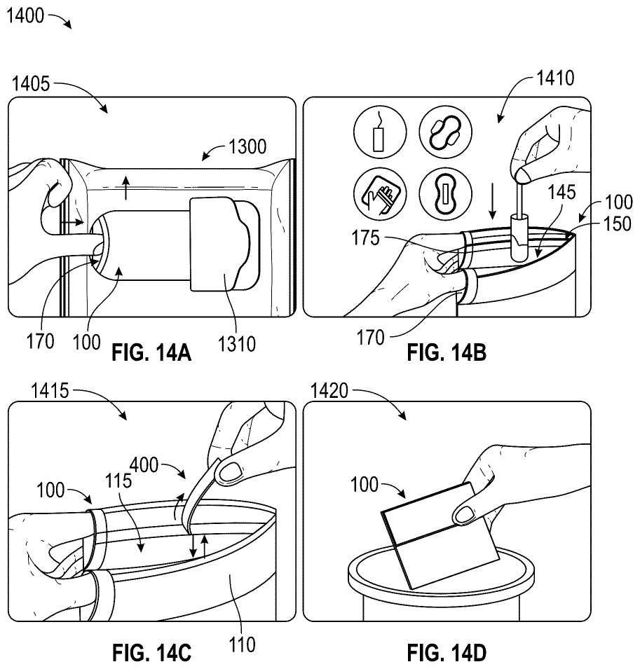

The disposal bag 100 of the invention is intended to be used by a woman who is on her period. A process 1400 for the use of the disposal bag 100 is shown in FIGS. 14A through 14D. In a first step 1405, as shown in FIG. 14A, the woman who need to remove and dispose of a period product, insert a finger into a front wall finger slot 170 opening and removes a disposal bag 100 from a dispenser body 1305. In a second step 1410, as shown in FIG. 14B, the woman inserts a finger in each of the front wall finger slot 170 and the rear wall finger slot 175 and spreads her finger so as to open the opening 150 so the used period product can be placed into the receptacle 145. In step three, as shown in FIG. 14C, she removes the strip from the adhesive strip 405 and then presses her fingers together so the rear wall 115 is sealed to the front wall 110 to close and seal the receptacle 145. Then, in step four, as shown in FIG. 14D, the disposal bag 100 containing the period product can be discreet disposed of.

The disposal bag 100 offers an alternative to the traditional way that women dispose of the products they use every month. The disposal bag 100 is easy to use, comfortable for someone's fingers, has the ability to open and close with one hand in order for the other hand to take out the used tampon, reduces leaks, reduces smell, and is much more discreet when it is thrown away since it looks like a piece of toilet paper.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person of ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and to include zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A disposal bag for disposal of a feminine hygiene product, the disposal bag comprising:
a bag body comprising a front wall and a rear wall, the bag body having a left side, a right side, a bottom, and a top, wherein the top includes a closeable opening that when open provides access to a receptacle compartment between the front wall and the rear wall;
a bag opening mechanism adapted to allow a user to separate a top portion of the front wall from a top portion of the rear wall to form the opening to allow a feminine hygiene product to be placed within the receptacle compartment; and
a sealing mechanism adapted to adjoin the top portion of the front wall to the top portion of the rear wall to close the opening and secure the feminine hygiene product within the disposal bag,
wherein the bag opening mechanism comprises a front wall finger slot on the front wall of the bag body and a rear wall finger slot on the rear wall of the bag body, wherein the front wall finger slot has a front wall finger slot opening on or near the left or right side, wherein the rear wall finger slot has a rear wall finger slot opening on or near the same left or right side, and wherein the front wall finger slot extends across at least 55 percent of the width of the front wall of the bag body.

2. A disposal bag according to claim 1 wherein the rear wall finger slot extends across at least 55 percent of the width of the rear wall of the bag body.

3. A disposal bag according to claim 1 wherein the front wall finger slot extends across at least 75 percent of the width of the front wall, and wherein the rear wall finger slot extends across at least 75 percent of the width of the rear wall of the bag body.

4. A disposal bag according to claim 1 wherein the sealing mechanism comprises a strip of adhesive that extends across the majority of the rear wall or the front wall near the opening.

5. A disposal bag according to claim 1 wherein the front wall finger slot extends at least two inches.

6. A disposal bag according to claim 1 wherein the front wall finger slot opening is within one inch of the left side or right side of the bag body.

7. A disposal bag according to claim 1 wherein the front wall finger slot is at least partially closed on its end opposite to the front wall finger slot opening.

8. A disposal bag according to claim 1 wherein the bag body is sized and shaped to resemble a sheet of toilet paper.

9. A disposal bag for disposal of a feminine hygiene product, the disposal bag comprising:
a bag body comprising a front wall and a rear wall, the bag body having a left side, a right side, a bottom, and a top, wherein the top includes a closeable opening that when open provides access to a receptacle compartment between the front wall and the rear wall;
a bag opening mechanism adapted to allow a user to separate a top portion of the front wall from a top portion of the rear wall to form the opening to allow a feminine hygiene product to be placed within the receptacle compartment; and
a sealing mechanism adapted to adjoin the top portion of the front wall to the top portion of the rear wall to close the opening and secure the feminine hygiene product within the disposal bag,
wherein the bag opening mechanism comprises a front wall finger slot on the front wall of the bag body and a rear wall finger slot on the rear wall of the bag body, wherein the front wall finger slot has a front wall finger slot opening on or near the left or right side, wherein the rear wall finger slot has a rear wall finger slot opening on or near the same left or right side, and wherein the front wall finger slot is connected to the front wall on three sides.

10. A disposal bag according to claim 9 wherein the front wall finger slot is at least partially closed on its end opposite to the front wall finger slot opening.

11. A disposal bag according to claim 9 wherein the rear wall finger slot is connected to the rear wall on three sides.

12. A disposal bag according to claim 9 wherein the rear wall finger slot is at least partially closed on its end opposite to the front wall finger slot opening.

13. A disposal bag according to claim 9 wherein the front wall finger slot extends across at least 75 percent of the width of the front wall, and wherein the rear wall finger slot extends across at least 75 percent of the width of the rear wall of the bag body.

14. A disposal bag according to claim 9 wherein the sealing mechanism comprises a strip of adhesive that extends across the majority of the rear wall or the front wall near the opening.

15. A disposal bag according to claim 9 wherein the front wall finger slot extends at least two inches.

16. A disposal bag according to claim 9 wherein the front wall finger slot opening is within one inch of the left side or right side of the bag body.

17. A disposal bag according to claim 9 wherein the bag body is sized and shaped to resemble a sheet of toilet paper.

18. A method of disposing of a feminine hygiene product, the method comprising:
providing a disposal bag comprising:
a bag body comprising a front wall and a rear wall, the bag body having a left side, a right side, a bottom, and a top, wherein the top includes a closeable opening that when open provides access to a receptacle compartment between the front wall and the rear wall;
a bag opening mechanism adapted to allow a user to separate a top portion of the front wall from a top portion of the rear wall to form the opening to allow a feminine hygiene product to be placed within the receptacle compartment; and
a sealing mechanism adapted to adjoin the top portion of the front wall to the top portion of the rear wall to close the opening and secure the feminine hygiene product within the disposal bag,
wherein the bag opening mechanism comprises a front wall finger slot on the front wall of the bag body and a rear wall finger slot on the rear wall of the bag body, wherein the front wall finger slot has a front wall finger slot opening on or near the left or right side, and wherein the rear wall finger slot has a rear wall finger slot opening on or near the same left or right side;
inserting a first finger of a first hand into the front wall finger slot;
inserting a second finger of the first hand into the rear wall finger slot;
separating the first finger from the second finger to open the opening;
placing a used period product through the opening and into the receptacle compartment using a second hand;
moving the first finger towards the second finger to close the opening and to adjoin the top portion of the front wall to the top portion of the rear wall across a majority of the width of the bag body; and
disposing of the disposal bag.

19. A method according to claim 18 wherein the sealing mechanism comprises a strip of adhesive and further comprising the step of removing a cover from the strip of adhesive.

20. A method according to claim 18 wherein further comprising the step of removing the disposal bag from a dispenser system, wherein the dispenser system comprises a dispenser body having a sealable dispenser opening exposing a plurality of disposal bags, and wherein at least a portion of the bag opening mechanism is exposed in the dispenser opening.
